(19) United States
(12) Patent Application Publication
(10) Pub. No.: US 2023/0313607 A1
(43) Pub. Date: Oct. 5, 2023

(54) CHAIN SHROUD FOR ROLLER SHADE

(71) Applicant: ZMC Metal Coating, Inc., Woodbridge (CA)

(72) Inventor: Philip NG, Thornhill (CA)

(73) Assignee: ZMC Metal Coating, Inc., Woodbridge (CA)

(21) Appl. No.: 17/729,314

(22) Filed: Apr. 26, 2022

(30) Foreign Application Priority Data
Mar. 29, 2022 (CA) 3153589

(51) Int. Cl. E06B 9/42; E06B 9/78

(52) U.S. Cl. CPC E06B 9/42; E06B 9/78

(57) ABSTRACT

A shroud for the drive chain of a roller blind. The drive chain has s a series of balls mounted on a cord or wire and is in the form of a pair of leg members forming a loop. The shroud comprises an elongate body having opposed open ends with an internal passageway extending therebetween. The body has an enclosed exterior surface extending between the open ends. A longitudinal internal baffle may extend between the open ends, segmenting the internal passageway into two longitudinal channels, each channel extending between the open ends and dimensioned to slidably receive one of the pair of chain leg members therethrough. The baffle may have a longitudinal slot extending along its length, where the slot is dimensioned to permit the receipt of the cord or wire of the drive chain, and is dimensioned to preclude the passage of the balls of the drive chain therethrough.

### CROSS REFERENCE TO RELATED APPLICATIONS

This application claims priority on and the benefit of Canadian Patent Application No. 3153589 filed on 29 Mar. 2022.

### TECHNICAL FIELD

This invention relates to the field of roller shades, and in particular to a new and novel shroud to encompass the operational chain or cord of a roller shade.

### BACKGROUND

Roller shades have become an increasingly common window covering and are used in both residential and commercial applications alike. Commonly, the shade fabric of a roller shade is raised or lowered through pulling on one end of a looped chain or cord that extends from a clutch or drive mechanism, typically located at or within the head rail of the roller blind, downwardly along the side of a window. While such mechanisms have proven to be a useful and efficient means to quickly and easily raise or lower the fabric of a roller shade in front of a window pane, it has been realized that in some instances the loop of chain or cord extending downwardly along the window frame can present a strangulation hazard for small children, and potentially pets. For that reason, many jurisdictions require the bottom looped end of the chain or cord to be rigidly secured to the window frame, making it difficult to be accessed by a small child. However, in spite of such regulations and the various structures that have been proposed to secure the ends of chains or cords to a window frame, in some applications there still exists the ability for a small child to potentially become entrapped between the two legs of a looped chain or cord, causing injury or death. Accordingly, there continues to exist a need for improved safety measures that can be used in conjunction with chains or cords that operate roller blinds.

### BRIEF SUMMARY OF THE INVENTION

In an embodiment there is presented a shroud for the drive chain of a roller blind, the drive chain comprising a series of generally spherical balls mounted in a spaced apart configuration on a cord or wire, the drive chain in the form of a pair of chain leg members joined together and forming a loop, the shroud comprising an elongate body having opposed open ends with a longitudinal internal passageway extending between the opposed open ends, the elongate body having a fully enclosed exterior surface extending between the open ends, a longitudinal internal baffle extending between the open ends and segmenting the longitudinal internal passageway into two longitudinal channels, each longitudinal channel extending between the open ends and dimensioned to slidably receive one of the pair of chain leg members therethrough, the longitudinal internal baffle having a longitudinal slot extending along its length, the slot dimensioned to permit the receipt of the cord or wire of the drive chain therethrough, the longitudinal slot dimensioned to preclude the passage of the balls of the drive chain therethrough.

In a further embodiment the invention comprises a shroud for the drive chain of a roller blind, the drive chain comprising a series of generally spherical balls mounted in a spaced apart configuration on a cord or wire, the drive chain in the form of a pair of chain leg members joined together and forming a loop, the shroud comprising an elongate body having opposed open ends with a longitudinal internal passageway extending between the opposed open ends, the elongate body having a fully enclosed exterior surface extending between the open ends, the longitudinal passageway dimensioned to slidably receive the pair of chain leg members therethrough, wherein the pair of chain leg members is receivable through the elongate passageway, wherein a lower end of each of the chain leg members extends through the same open end of the elongate body and is slidably secured to a chain retainer, wherein the shroud is received about the chain leg members of the drive chain between the chain retainer and a drive mechanism of the roller blind.

In another embodiment there is provided a shroud for the drive chain of a roller blind, in combination with a chain retainer, the drive chain comprising a series of generally spherical balls mounted in a spaced apart configuration on a cord or wire, the drive chain in the form of a pair of chain leg members joined together and forming a loop, the shroud comprising an elongate body having opposed open ends with a longitudinal internal passageway extending between the open ends, the elongate body having a fully enclosed exterior surface extending between the open ends, the chain retainer securable to the frame of a window and slidably receiving the looped chain leg members, wherein the pair of chain leg members are received through the longitudinal internal passageway of the elongate body, and wherein, when the drive chain is oriented in a vertical configuration, the shroud has a resting position where it contacts the chain retainer, and a displaced position where it has been slid vertically upward along the chain leg members to expose a length of the drive chain between the shroud and the chain retainer.

### BRIEF DESCRIPTION OF THE DRAWINGS

For a better understanding of the present invention, and to show more clearly how it may be carried into effect, reference will now be made, by way of example, to the accompanying drawings which show exemplary embodiments of the present invention in which:

FIG. 1 is a side perspective view of a roller shade upon which is employed a shroud constructed in accordance with an embodiment of the invention.

FIG. 2 is an upper side perspective view of one embodiment of the shroud shown in FIG. 1.

FIG. 3 is an end view of the embodiment of the shroud shown in FIG. 2.

FIG. 4 is an upper side perspective view of a second embodiment of the shroud shown in FIG. 1.

FIG. 5 is an end view of the embodiment of the shroud shown in FIG. 4.

FIG. 6 is an upper side perspective view of a third embodiment of the shroud shown in FIG. 1.

FIG. 7 is an end view of the embodiment of the shroud shown in FIG. 6.

FIG. 8 is a view of the clutch/drive system of the roller shade of FIG. 1, having a drive chain secured thereto with the shroud removed.

FIG. 9 is a view similar to FIG. 8, wherein a shroud constructed in accordance with an embodiment of the invention has been received over the drive chain, and wherein the lower looped portion of the drive chain is shown secured by a chain retainer.

FIG. 10 is a view similar to FIG. 9, wherein the shroud has been lifted in an upward direction, exposing the lower portion of the drive chain.

### DETAILED DESCRIPTION OF PREFERRED EMBODIMENTS

The present invention may be embodied in a number of different forms. The specification and drawings that follow describe and disclose some of the specific forms of the invention.

With reference to the attached drawings, there is shown a relatively generic roller shade 1 that is comprised generally of a head rail 2 and shade or blind fabric 3. As in the case of most common roller shades, blind fabric 3 is raised or lowered through pulling on one of a pair of chain or cord leg members 4 which are joined together to form a loop. With reference to FIG. 8, the looped chain or cord 4 is typically received around a clutch or drive mechanism 5, that is in turn secured or otherwise connected to a roller tube upon which blind fabric 3 is rolled or unrolled. Also as in the case of most roller blinds, pulling on one of the two chain or cord leg members 4 will cause the roller shade to be rotated in a first direction whereas pulling on the other chain or cord leg member will cause the roller tube to be rotated in an opposite direction, such that the blind fabric is either raised or lowered.

Where the blind is operated through use of a chain, the chain is typically comprised of a series of generally spherical shaped balls 6 that are mounted in a spaced apart configuration on a cord or wire 7. Typically balls 6 are spaced apart at an approximate equal distance to facilitate their engagement with the roller blind clutch. As is mandated by certain jurisdictions, the lower end of the looped roller chain may be commonly received through or otherwise retained by a chain retainer 8. It will be appreciated that chain retainer 8 could take any one of a very wide variety of different configurations and structures, and that its primary purpose is to maintain the chain along the side of a window frame in order to help prevent an infant, or perhaps a pet, from being entangled therein.

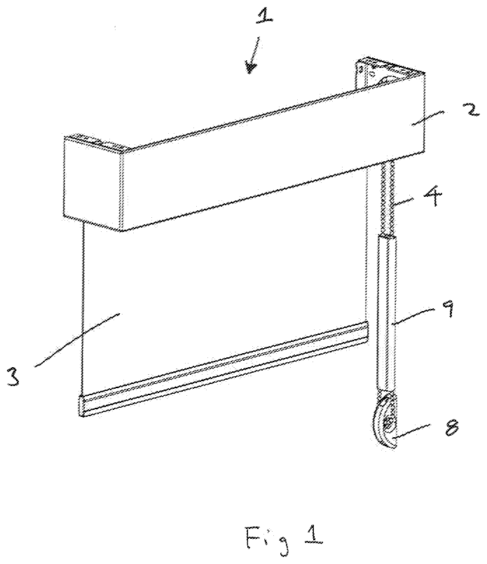

In accordance with the invention, there is provided a shroud 9 for chain leg members 4 that comprises an elongate body 10 having opposed open ends 11 and 12, respectively. Elongate body 10 has a fully enclosed exterior surface extending between open ends 11 and 12. In one embodiment, elongate body 10 is oblong in cross section. Elongate body 10 further comprises a longitudinal internal passageway 13 that extends between open ends 11 and 12, and through which chain leg members 4 can be slidably received. As shown specifically in FIGS. 1, 9 and 10, during operation, both of chain leg members 4 extend through internal passageway 13 with the lower ends of each chain member extending through open end 12 and then slidably secured to chain retainer 8. In this manner, shroud 9 is received about the chain leg members between chain retainer 8 and clutch 5. As demonstrated in FIG. 9, in a rest configuration, open end 12 contacts or rests against chain retainer 8, whereas in an alternate position shroud 9 may be lifted to the point where open end 11 is close to or contacts clutch 5, thereby exposing a portion of each of the pair of chain leg members immediately above chain retainer 8.

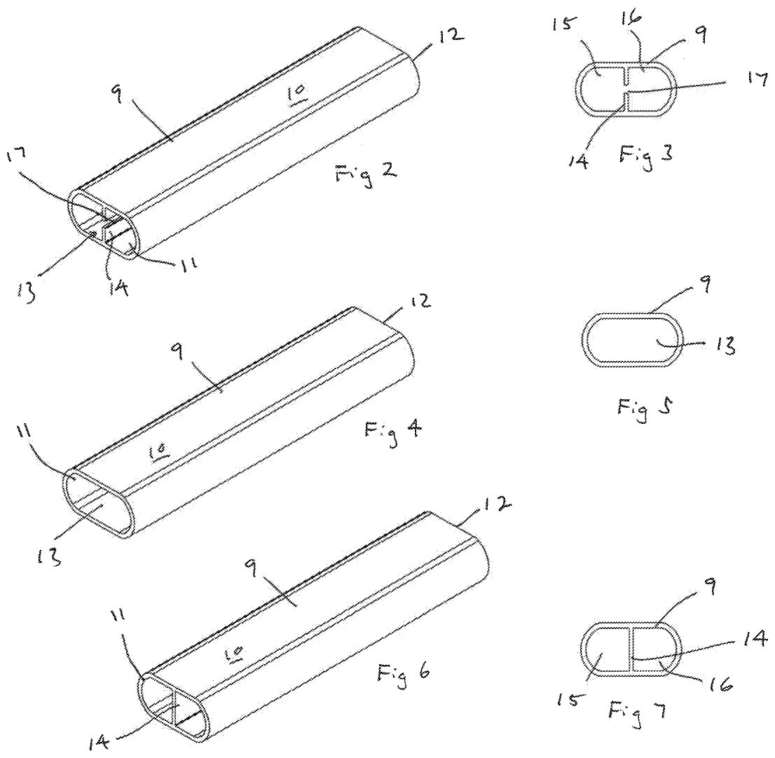

FIGS. 6 and 7 illustrate one embodiment of shroud 9. In this embodiment the shroud includes a longitudinal internal baffle 14 that extends between open ends 11 and 12, thereby segmenting longitudinal internal passageway 13 into two longitudinal channels, 15 and 16 respectively. Each of the longitudinal channels 15 and 16 thus extends between open ends 11 and 12 and is dimensioned to slidably receive one of the pair of chain leg members 4. In one instance, baffle 14 is a solid, longitudinally oriented, planar structure secured along opposed longitudinal edges thereof to opposite sides of an internal longitudinal surface of passageway 13 (see FIGS. 6 and 7). In an alternate configuration, baffle 14 may include a longitudinal slot 17 extending along its length (see FIGS. 2 and 3). Slot 17 is preferably dimensioned to permit to the receipt of cord or wire 7 therethrough, while at the same time precluding the passage of balls 6 through the slot. That is, the slot is sized to allow shroud 9 to be received over a looped pair of chain leg members 4 by slidably engaging slot 17 with the looped pair of chain leg members between two adjacent balls.

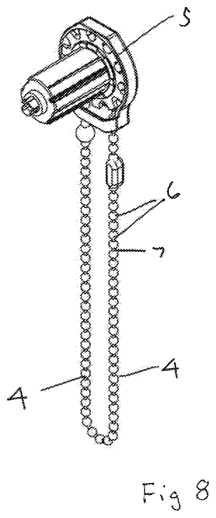

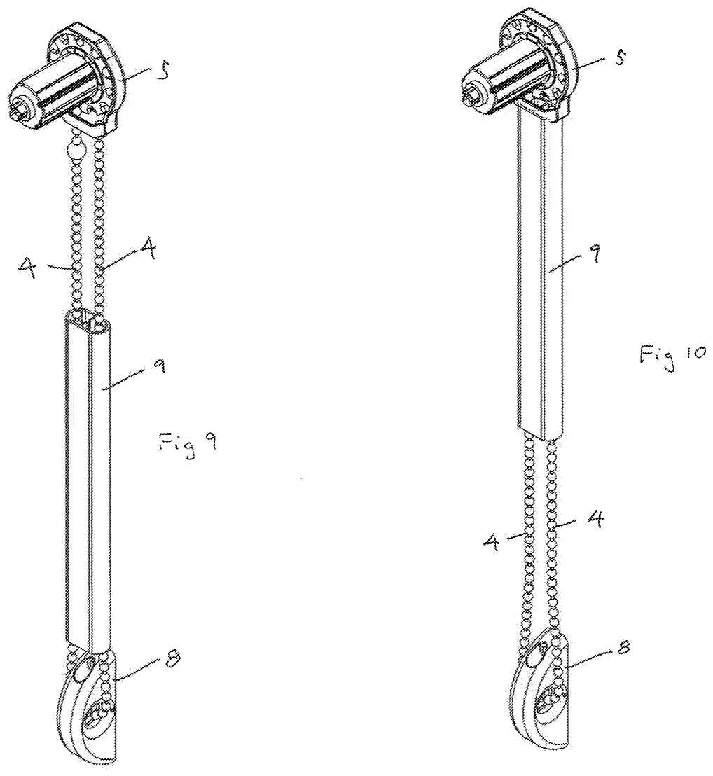

FIGS. 4 and 5 illustrate yet a further embodiment of shroud 9 where internal passageway 13 is open and no baffle is utilized. In this embodiment the two chain leg members are merely inserted through internal passageway 13, after which the lower looped portion of the chain is secured or otherwise received about chain retainer 8.

Regardless of which of the particular embodiments of shroud 9 described above is utilized, it will be appreciated that when assembled over the drive chain or cord of a roller blind, between the drive mechanism or clutch and the chain retainer, shroud 9 will serve to effectively retain each of the chain leg members in a close relationship, thereby precluding an infant or pet from becoming entangled therewith. To operate the roller blind, an individual need only grasp the shroud and lift it vertically upward, sliding it along the drive chain and exposing a lower portion of the looped drive chain between the bottom of the shroud and the chain retainer. The desired leg of the chain that is exposed below the shroud can then be pulled in a downward direction to either deploy or retract the blind fabric from the roller blind. Once the blind fabric has been adjusted to its desired level, releasing the shroud allows it to slide back downwardly along both legs of the chain until it once again comes to rest on the chain retainer, and once again provides an effective means to prevent an infant or pet from becoming entangled in the two chain leg members.

It will further be appreciated that to minimize noise of operation, in an embodiment the shroud may be formed from a relatively soft plastic or plastic-like material having generally rounded edges that not only aid in reducing noise when coming into contact with a chain, but that also make the exterior of the shroud more comfortable to grasp by an individual. In other instances the shroud may be formed from wood or other natural material. It will further be appreciated that by forming the elongate body of the shroud with a fully enclosed exterior surface, the likelihood of an individual's hand becoming pinched between the shroud and the chain is minimized, noise that would otherwise be created through contact of the balls of the chain with holes or other openings in the exterior of the shroud is eliminated, a “cleaner look” is presented, and the ability for dust and debris to enter the shroud and to be deposited upon the chain is reduced. Where the shroud is formed from a plastic or plastic-like material, the described structure also presents the ability for the shroud to be formed through a single extrusion, thereby helping to minimize manufacturing costs. If desired, the shroud could be formed from a transparent or translucent material to minimize its visual appearance. In other cases the shroud may be coloured to match the colour of the window frame.

It is to be understood that what has been described are the preferred embodiments of the invention. The scope of the claims should not be limited by the preferred embodiments set forth above, but should be given the broadest interpretation consistent with the description as a whole.

I claim:

1. A shroud for the drive chain of a roller blind, the drive chain comprising a series of generally spherical balls mounted in a spaced apart configuration on a cord or wire, the drive chain in the form of a pair of chain leg members joined together and forming a loop, the shroud comprising:
an elongate body having opposed open ends with a longitudinal internal passageway extending between the opposed open ends, the elongate body having a fully enclosed exterior surface extending between the open ends;
a longitudinal internal baffle extending between the open ends and segmenting the longitudinal internal passageway into two longitudinal channels, each longitudinal channel extending between the open ends and dimensioned to slidably receive one of the pair of chain leg members therethrough; and
the longitudinal internal baffle having a longitudinal slot extending along its length, the slot dimensioned to permit the receipt of the cord or wire of the drive chain therethrough, the longitudinal slot dimensioned to preclude the passage of the balls of the drive chain therethrough.

2. The shroud as claimed in claim 1, wherein the longitudinal slot is positioned in the longitudinal internal baffle to segment the baffle into two approximately equal portions, each portion secured along a longitudinal edge thereof to an internal longitudinal surface of the elongate body.

3. The shroud as claimed in claim 2, wherein the exterior surface of the elongate body is oblong and devoid of exterior corners.

4. The shroud as claimed in claim 2, in combination with a drive chain of a roller blind and a chain retainer, the drive chain in the form of a pair of chain leg members joined together and forming a loop, wherein the drive chain is received through the elongate body with one leg member extending through each of the longitudinal channels such that the leg members of the drive chain are separated by the internal baffle, wherein a lower end of each of the chain leg members extends through the same open end of the elongate body and is slidably secured to the chain retainer, wherein the shroud is received about the chain leg members of the drive chain between the chain retainer and a drive mechanism of the roller blind.

5. The shroud as claimed in claim 4, dimensioned to be slidable along the leg members of the drive chain from a position wherein one end of the shroud contacts the chain retainer, to a position wherein an opposite end of the shroud contacts the drive mechanism of the roller blind.

6. A shroud for the drive chain of a roller blind, the drive chain comprising a series of generally spherical balls mounted in a spaced apart configuration on a cord or wire, the drive chain in the form of a pair of chain leg members joined together and forming a loop, the shroud comprising:
an elongate body having opposed open ends with a longitudinal internal passageway extending between the opposed open ends, the elongate body having a fully enclosed exterior surface extending between the open ends, the longitudinal passageway dimensioned to slidably receive the pair of chain leg members therethrough,
wherein the pair of chain leg members is receivable through the elongate passageway, wherein a lower end of each of the chain leg members extends through the same open end of the elongate body and is slidably secured to a chain retainer, wherein the shroud is received about the chain leg members of the drive chain between the chain retainer and a drive mechanism of the roller blind.

7. The shroud as claimed in claim 6, wherein the elongate body has a longitudinal internal baffle extending between the open ends and segmenting the longitudinal internal passageway into two longitudinal channels, each longitudinal channel extending between the open ends and dimensioned to slidably receive one of the pair of chain leg members therethrough.

8. A shroud for the drive chain of a roller blind, in combination with a chain retainer, the drive chain comprising a series of generally spherical balls mounted in a spaced apart configuration on a cord or wire, the drive chain in the form of a pair of chain leg members joined together and forming a loop, the shroud comprising:
an elongate body having opposed open ends with a longitudinal internal passageway extending between the open ends, the elongate body having a fully enclosed exterior surface extending between the open ends;
the chain retainer securable to the frame of a window and slidably receiving the looped chain leg members;
wherein the pair of chain leg members are received through the longitudinal internal passageway of the elongate body; and
wherein, when the drive chain is oriented in a vertical configuration, the shroud has a resting position where it contacts the chain retainer, and a displaced position where it has been slid vertically upward along the chain leg members to expose a length of the drive chain between the shroud and the chain retainer.

9. The shroud in combination with a chain retainer as claimed in claim 8, wherein a longitudinal internal baffle extends between the open ends of the elongate body and segments the longitudinal internal passageway into two longitudinal channels, each longitudinal channel extending between the open ends and dimensioned to slidably receive one of the pair of chain leg members therethrough.

10. The shroud in combination with a chain retainer as claimed in claim 9, wherein the longitudinal internal baffle has a longitudinal slot extending along its length, the slot dimensioned to permit the receipt of the cord or wire of the drive chain therethrough, the longitudinal slot dimensioned to preclude the passage of the balls of the drive chain therethrough.

11. The shroud in combination with a chain retainer as claimed in claim 10, wherein the exterior surface of the elongate body is generally oblong in cross section.
